(19) United States
(12) Patent Application Publication
(10) Pub. No.: US 2003/0083977 A1
(43) Pub. Date: May 1, 2003

(54) System and method for providing electronic bulk buying

(76) Inventor: Majid Syed, Princeton, NJ (US)

Correspondence Address: Blaney Harper, Jones, Day, Reavis & Pogue, 51 Louisiana Avenue, NW, Washington, DC, 20001, US

(21) Appl. No.: 10/045,120

(22) Filed: Oct. 26, 2001

(51) Int. Cl. G06F 17/60

(52) U.S. Cl. 705/37

(57) ABSTRACT

One or more broadcast servers transmit information (advertisement content and multimedia data content) to one or more digital audio broadcast (iDAB) receivers over a network such as an in-band on-channel (IBOC) network. A client with an iDAB receiver is able to purchase multimedia content by a simple action through a man-machine interface (MMI). Furthermore, a mechanism is described for setting thresholds, wherein the thresholds define when actual broadcasting of the content should begin. The thresholding mechanism is implemented either in the iDAB receiver or in a Push-Pull gateway broadcasting the multimedia content. Bulk purchases are described, where such purchases are done via: direct order placement, indirect order placement, or via a B-server (over iBOC) download to receivers. Additionally, bulk purchase allows for the spreading of uplink traffic from consumer devices.

### RELATED APPLICATIONS

The present application is related to co-pending application entitled “System and Method for Providing a Push Gateway Between Consumer Devices and Remote Content Provider Centers”, assigned to the same assignee as the present application, which is incorporated herein by reference. Furthermore, the present application is related to co-pending application entitled “System and Method for a Push-Pull Gateway-Directed Digital Receiver”, assigned to the same assignee as the present application, which is incorporated herein by reference.

### FIELD OF INVENTION

The present invention relates generally to the field of broadcast communications. More specifically, the present invention is related to purchasing data content from a digital broadcast.

### BACKGROUND OF THE INVENTION

Definitions have been provided to help with a general understanding of network communications and are not meant to limit their interpretation or use thereof. Thus, one skilled in the art may substitute other known definitions or equivalents without departing from the scope of the present invention.

Datagram: A portion of a message transmitted over a packet-switching network. One key feature of a packet is that it contains the destination address in addition to the data. In IP networks, packets are often called datagrams.

Push: In client/server applications, to send data to a client with or without the client requesting it. The World Wide Web (WWW) is based on a Pull technology where the client browser must request a Web page before it is sent. Broadcast media, on the other hand, utilize Push technologies because information is sent out regardless of whether anyone is tuned in.

Increasingly, companies are using the Internet to deliver information Push-style. One example of a widely used Push technology is e-mail. This is a Push technology because you receive mail whether you ask for it or not—that is, the sender pushes the message to the receiver.

Pull: To request data from another program or computer. The opposite of Pull is Push, where data is sent with request being made. The terms Push and Pull are used frequently to describe data sent over the Internet. As mentioned earlier, the WWW is based on Pull technologies, where a page isn't delivered until a browser requests it. Increasingly, however, information services are harnessing the Internet to broadcast information using Push technologies. A prime example is the PointCast Network™.

WAP: The Wireless Application Protocol (WAP) is a secure specification that allows users to access information instantly via handheld wireless devices such as mobile phones, pagers, two-way radios, smart phones and communicators.

WAP supports most wireless networks. These include cellular digital packet data (CDPD), Code-Division Multiple Access (CDMA), Global System for Mobile Communications (GSM), PDC, PHS, Time Division Multiple Access (TDMA), FLEX (K56Flex), ReFLEX, iDEN, TETRA, DECT, DataTAC, and Mobitex. Additionally, WAP is supported by all operating systems. Ones specifically engineered for handheld devices include PalmOS®, EPOC®, Windows CE®, FLEXOS®, OS/9®, and JavaOS®.

Furthermore, WAPs that use displays and access the Internet run what are called microbrowsers—browsers with small file sizes that can accommodate the low memory constraints of handheld devices and the low-bandwidth constraints of a wireless-handheld network.

UDP: User Datagram Protocol (UDP) is a connectionless protocol that, like Transmission Control Protocol (TCP), runs on top of IP networks. Unlike TCP/IP, UDP/IP provides very few error recovery services, offering instead a direct way to send and receive datagrams over an IP network. It's used primarily for broadcasting messages over a network.

W-UDP: This is the transport layer that is responsible for moving WAP data from a sender to a recipient, and vice versa. WDP is similar to UDP and is the wireless equivalent of UDP.

Radio Broadcasting: Airborne transmission of audio signals via electromagnetic carrier waves accessible by a wide population by means of standard receivers, such as radios. Radio waves are not only deployed as a carrier in standard radio broadcasting, but also in wireless telegraphy, telephone transmission, television, navigation systems, and radar. Radio waves are of different length and usually identified by their frequency, i.e., the number of times per second that a periodic wave repeats. The shortest waves have the highest frequency, and the longest waves have the lowest frequency. A typical radio communication system features the following two main components: a transmitter and a receiver. The transmitter generates electrical oscillations at a radio frequency called the carrier frequency. In analog radio broadcasting, either the amplitude (AM) or the frequency (FM) itself may be modulated to vary the carrier wave, thereby producing sounds. At the receiver device, the antenna converts the incoming electromagnetic waves into electrical oscillations, which are then increased in intensity by amplifiers. Finally, a speaker in the receiving device converts the electrical impulses into sound waves audible to the human ear. Several types of noise such as static—caused by electrical disturbances in the atmosphere, hum—a steady low-frequency note commonly produced by the frequency of the alternating-current power supply, hiss—a steady high frequency note, or a whistle—a pure high-frequency note produced by unintentional audio-frequency oscillation, cause broadcast interference and distortion at the receiver end.

Currently, approximately 10,000 radio stations are located throughout the U.S.A., reaching a vast audience. U.S. radio stations are operating with analog technology and are almost evenly divided between two broadcast spectrums: amplitude modulation (AM) at 0.525-1.705 MHz and frequency modulation (FM) at 88-108 MHz. A new emerging technology known as in-band on-channel (IBOC) allows these radio stations to deploy digital transmission technology within existing bandwidths allocated to the AM and FM stations. Digital transmission allows data processing in strings of 0's and 1's, rather than analog transmission by means of electronic signals of varying frequency or amplitude that are added to the carrier wave of a given frequency. Digital technology is primarily deployed in new communication media, such as computers and fiber-optic networks. By way of example, a modem is used to modulate outgoing digital signals from a computer to analog signals for a conventional copper twisted pair telephone line, to demodulate the incoming analog signal, and to convert it to a digital signal for the computer in order to facilitate communication via the Internet.

The Internet is an international system of computer networks, comprised of a series of computers interconnected by means of data lines, routers, and/or wireless communication links. Each computer, as a part of the Internet, serves, amongst other things, as a storage device for data flowing between computers. The Internet facilitates data interchange, as well as remote login, electronic mail, and newsgroups. One integral part of the Internet is the World Wide Web (hereafter “the Web” or WWW), a computer-based network of information resources. The Internet is also a transmission medium for emails, short messages (SMS) or other data content.

Like traditional computer networks, the Internet operates within the client-server format. Servers are typically remote computer systems that store and transmit electronic documents over the network to other computers upon request. Clients, on the other hand, are computer systems or other interactive devices that request/receive the stored information from a server. A client may be a personal computer or a wireless device such as a handheld, a cellular phone or other Internet-enabled mobile device that is capable of two-way communication.

In the traditional client-server model, a client requests a service or data from a server, which then responds by transmitting the data to the client. As mentioned earlier, this is known as “Pull” technology because the client “Pulls” data from the server. The Web is a typical example of Pull technology, wherein a user sends a data request by entering a Uniform Resource Locator (URL) to a server, which then answers, by sending the Web site at the requested URL back to the user. In contrast, “Push” technology, which also operates within the client-server model, does not require a user initiated data request prior to the transmission of data. Such data transmissions are common in the so-called Web Casting technology, i.e., the prearranged updating of news, weather, or other selected information on the interface of a device with digital capabilities through periodic and generally unobtrusive transmission. Currently, Web Casting technology primarily targets computer users. Yet, as described above, there is a huge audience in the radio broadcast area, and there exists a strong demand for data casting content such as: song titles, artist names, lyrics, traffic and weather news, stock market quotes, pager messages or complementary product information. New radio receivers with Liquid Crystal Displays (LCD) combined with the deployment of the inbound on-channel (IBOC) technology facilitate such data casting.

All data transmitted over the Internet is broken down into small units of data called packets. Each packet is assigned a unique number, which is later used to re-assemble the data packets when they arrive at their destination. For this reason, the Internet is also called a packet-switched network. The series of protocols used to achieve packet-switching is Transmission Control Protocol/Internet Protocol (TCP/IP). In order to standardize the communication between servers and clients on the Internet, additional protocols that are usually packaged with TCP/IP are used for the transmission of data.

As known in the art, network communication is based on the seven layer model Open System Interconnection (OSI). Information being transferred from a software application in one communication system to another, e.g., from one computer to another via the Internet, must pass through each of the OSI layers. Each layer has a different task in the information exchange process and the actual information exchange occurs between peer OSI layers. Each layer in the source system adds control information to the transmission data and each layer in the destination system analyzes and removes the control information from that data. At the lowest layer, the physical layer, the entire information packet is placed onto the network medium where it is picked up by the receiving unit. In this model, protocols represent and describe the formal rules and conventions that govern the exchange of information over a network medium. The protocol likewise implements the functions of one or more of the OSI layers. For example, the transport protocol for Web sites is the Hyper Text Transfer Protocol (HTTP), for e-mails Simple Mail Transfer Protocol (SMTP), and for software programs File Transfer Protocol (FTP). Premised in the functions of the used network layers to be implemented and the tasks to be achieved during the communication, protocols vary in their specifications. Many additional protocols exist to assist in standardizing communication standards.

Web sites are formatted in Hyper Text Markup Language (HTML), Wireless Markup Language (WML), or Extensible Markup Language (XML). These are standard text formatting languages for interconnected networks such as the Internet. So-called Web browsing software interprets HTML, WML, and/or XML documents, thereby allowing users to view Web sites on their display screen. As in the case with protocols, additional languages exist for the marking-up of Web sites or other data.

The data link between the Internet and a wireless device is established via a wireless modem or an antenna and a wireless carrier service using radio frequencies, rather than via twisted-pair or fiber-optic cables. Content for wireless services is marked up in Wireless Application Protocol (WAP), rather than HTTP. For that reason, Internet servers cannot directly communicate with, and content cannot be directly sent to wireless devices.

Wireless devices equipped with a communication interface such as a modem are able to download various forms of data content. One of the problems facing wireless broadcasters is the inability to stream multimedia data, especially multimedia audio data content, to wireless devices in real time, due to the limited bandwidth considerations at the transmitter's side and limited data rate reception at the receiver's side.

With the advent of many compression techniques such as motion picture encoding group (MPEG) format, digital audio formats such as MP3's are becoming increasingly popular. Some prior art systems have attempted to stream such compressed content over networks such as the Internet, and some prior art systems have gone even further and implemented e-commerce models for purchasing such digital content. None of these business models, however, provide for an appropriate mechanism for purchasing such digital content, while keeping in mind the limited bandwidth considerations. Furthermore, these prior art systems fail to provide for a user, broadcaster, or content provider definable threshold (which is time or content dependent) for downloading such content. Additionally, the prior art systems fail to disclose purchasing data content (to be downloaded) by a Push-Pull gateway over an in-band on-channel (IBOC) network.

### SUMMARY OF THE INVENTION

The present invention provides for a method and system for point-of-sale (POS) and purchase of data content. In the preferred embodiment, one or more broadcast servers transmit information to one or more receivers over a network such as an in-band on-channel (IBOC) network. Additionally, the receiver is a digital audio broadcast (e.g., iBiquity's iDAB™) receiver and the broadcast information comprises advertisement content and multimedia audio content. Furthermore, in the preferred embodiment, a client with an iDAB receiver is able to purchase multimedia content by a simple action through a man-machine interface (MMI). The present invention also provides for a mechanism for setting thresholds that define the amount of multimedia content to be purchased (by the client) before actual broadcast of the content is to begin. The thresholding mechanism is implemented either in the iDAB receiver or in a Push-Pull gateway broadcasting the multimedia content.

In the preferred embodiment, the broadcast content comprises advertisements and multimedia data content. Users at the receivers end are able to interact with the man-machine interface and purchase multimedia content. Additionally, users are able to respond to advertisements rendered in the man-machine interface and purchase merchandise. For example, by clicking on an advertisement, users are able to buy multimedia audio content, wherein the content is either sent to the user's physical address as a compilation CD or the content is uploaded to the receiver. Also, the present invention provides for a method and system for bulk-downloading multimedia content using thresholding and via protocols such as, but not limited to, the point-to-point protocol (PPP), transmission control protocol/internet protocol (TCP/IP), and wireless datagram protocol (WDP).

### BRIEF DESCRIPTION OF THE DRAWINGS

FIG. 1 illustrates a Push-Pull Gateway (hereafter iPPG or iGateway) End-to-End (E2E) system used to implement the present invention.

FIG. 2 illustrates a table outlining a brief description of the various elements that make up the system in FIG. 1, and the interfaces associated with these elements.

FIG. 3 illustrates, in greater detail, the functionality of iPPG used to implement the present invention.

FIG. 4 illustrates how incoming data is handled at the client (receiver's end—an IBOC-enabled mobile device).

FIG. 5 illustrates in greater detail the interaction between the turbo broadcast layers and the digital receiver.

FIG. 6 illustrates a more specific instance wherein the application software layer of FIG. 5 is a vendor interface.

FIG. 7 illustrates the present invention's method associated with a passive mode point-of-sale (POS) and bulk purchase of data content.

FIG. 8 illustrates a specific embodiment of the present invention's bulk purchase procedure, wherein a direct order is placed from a receiver to a direct order service (DOP) without an intermediate entity.

FIG. 9 illustrates the relation between a GPS time stamp and broadcast data content.

FIG. 10 illustrates the present invention's active mode real-time indirect order placement using transmission control protocol/Internet protocol (TCP/IP).

FIG. 11 illustrates the active mode real-time indirect order placement embodiment of the present invention, wherein communication between a receiver and the B-server is accomplished by using a B-Server over IDAB as the downlink and a receiver over the traditional uplink.

### DESCRIPTION OF THE PREFERRED EMBODIMENTS

While this invention is illustrated and described in a preferred embodiment, the invention may be produced in many different configurations, forms and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

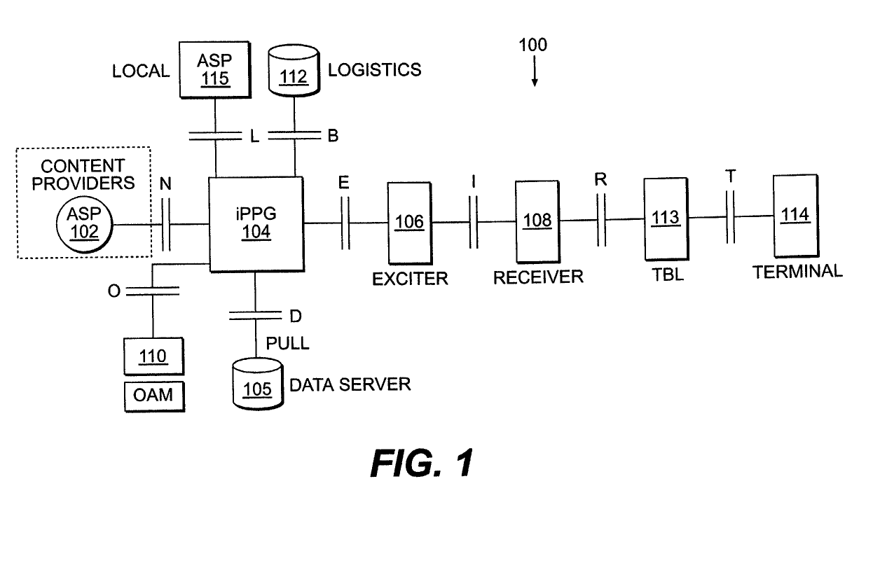

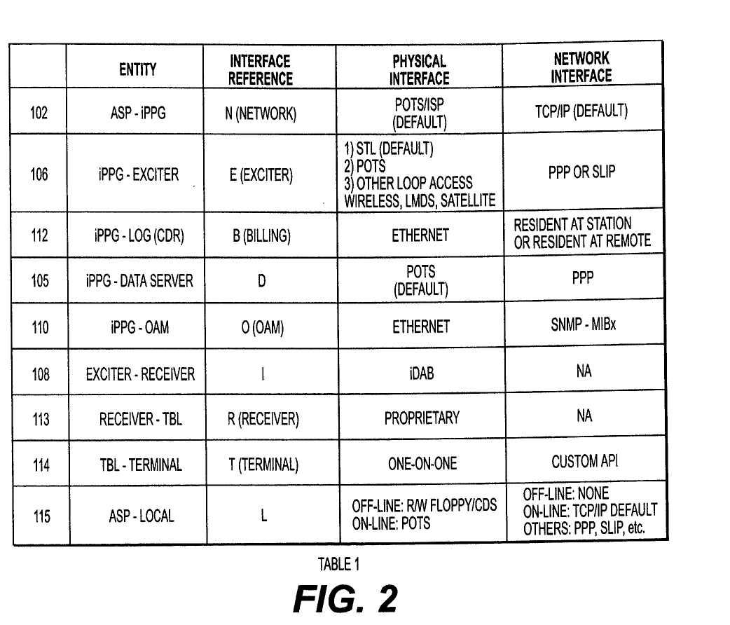

FIG. 1 illustrates a Push-Pull Gateway (hereafter iPPG or iGateway) End-to-End (E2E) system 100 used to implement the present invention. This Push-Pull Gateway system is described in greater detail in co-pending application entitled “System and Method Providing a Push Gateway Between Consumer Devices and Remote Content Provider Centers”. The system components (to be described below) of the iPPG collectively achieve the Push, Pull, and send features of the gateway (iPPG). In FIG. 1, the remote application service providers (ASPs) 102 submit (or Push) content, over a network N (e.g., the Internet) via a protocol such as HTTP, to the iGateway 104. Optionally, a local ASP 115 can also be accessed via a local ASP interface L. The iGateway 104 is able to either accept or reject such requests by ASPs 102 and 115. The iGateway is also able to retrieve (or Pull) data server's 105 content as selected by a station operator over a network such as the Internet. The iPPG, with the help of an operation administration module (OAM) 110, prioritizes, schedules, and sends datagrams to the exciter 106 over interface E. Receiver 108 (a client such as iBiquity's proprietary iBOC receiver/client) acquires the data and turbo broadcast layer 113 de-encapsulates the data. The data is then displayed on terminal 114. Furthermore, a billing procedure keeps track of all data pushes (via pre-defined logistics 112) from various ASPs for billing purposes. As will be detailed later, when in listen mode, the data receiver 108 displays the received data continuously, or, upon demand, as per filtration activated by subscriber. A brief description of the various elements that make up the system in FIG. 1 and the interfaces associated with these elements are described in further detail in Table 1 as shown in FIG. 2.

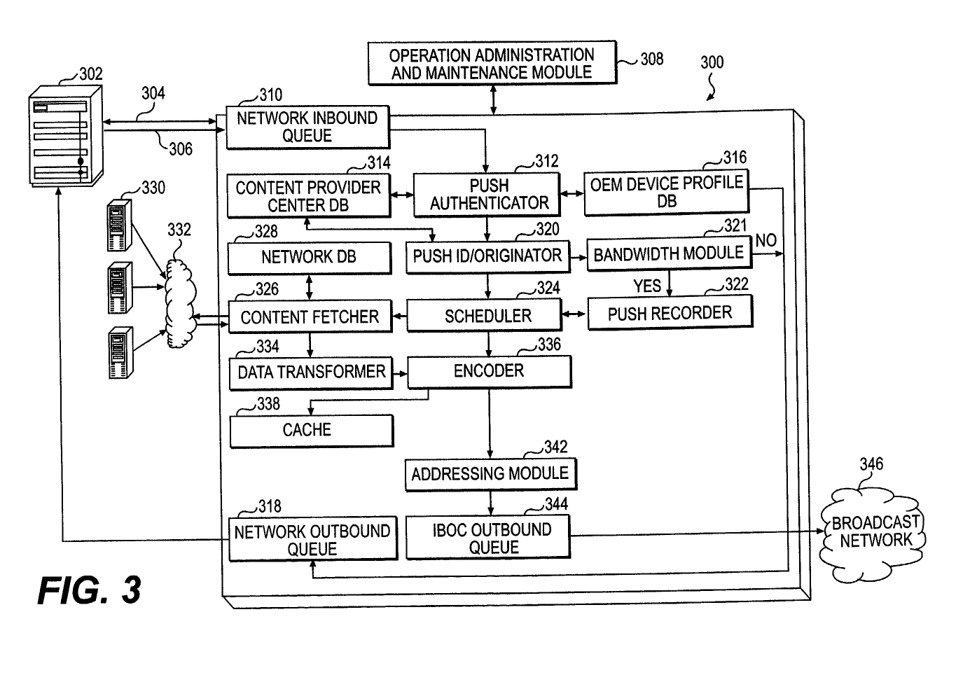

FIG. 3 illustrates, in greater detail, the functionality of iPPG 300. The content provider center 302 establishes session 304 with iPPG 300. The established session provides for a data link (such as a link based upon a standard peer-2-peer protocol or any other data communication link). Furthermore, as shown, an operation administration and maintenance module (OAM) 308 controls, in an event driven manner, the iPPG 300. Content provider center 302 is able to submit a Push request 306 to the iPPG 300, where it is first received by the network inbound queue 310. Next, Push authenticator 312 identifies and authenticates content provider center 302 as the Push initiator. This authentication is performed based upon information stored in content provider center database 314. Furthermore, the Push authenticator 312 checks if the Push message contains any client device capabilities queries (a query requesting client's requested format (e.g., Text, HTML, WML, etc.), and if so, the queries are passed onto OEM device profile database 316, wherein the device profiles of queried devices are extracted and passed on to the network outbound queue 318 for transmission to the content provider center 302. On the other hand, if the Push message is made up of just data content to be Pushed (or a request for data content to be Pushed), Push ID/originator ID numbers 320 are extracted from the content provider center database 314 and passed onto the Push recorder 322 for storage.

A scheduler 324, then parses control entity of the message and passes such information to bandwidth module 321. The bandwidth module 321 is used for bandwidth management purposes. Additionally, the bandwidth module determines time/schedule for contained instructions and determines if requested bandwidth is already assigned for the time of day. If so, the bandwidth module 321 passes the information to network outbound queue 318 with options of available bandwidth slots. If request is not conflicting, it passes such information for storage to Push recorder 322. If instruction extracted by the scheduler 324 includes retrieving data, the content fetcher 326, in conjunction with the scheduler 324 and a network database 328, Pulls data from content providers 330 via a network 332, such as the Internet. The Pulled data is then transformed and encoded (via data transformer 334 and encoder 336, respectively) into a format requested by the client. Furthermore, data transformer 334 and encoder 336 split the data into octet data blocks, assign serial numbers to all packets, and pass them on to addressing module 342 and cache 338. Additionally, a bandwidth module 340 is used for bandwidth management purposes. Lastly, the data from the addressing module is passed onto the IBOC outbound queue 344 to various end devices linked to a broadcast network 346, such as an IBOC network.

The iPPG maintains a log of broadcast detail records from the exciter to the iPPG (e.g., for the purposes of billing). The iPPG also supports 7 and 8 bit data coding schemes for OTA efficiency (local function in iPPG). In one variation, to improve OTA efficiency, a numeric identifier is used instead of a URI. In this case, a broadcast interim authority assigns numbers to well-known user agents to avoid the overhead of sending a URI. The broadcast interim authority publishes a list of assigned numerical identifiers. If an iPPG requests to Push content with an application address URI that the iPPG recognizes as a URI (which has broadcast interim authority assigned numeric identifier), the URI is replaced with the numeric identifier. In an extended variation, the Push initiator requests a numeric identifier to be used (an identifier that is not registered). It should, however, be noted that special care should be taken to avoid assigning the same identifier to ASPs. The iPPG is also involved in reliability, rate at which broadcast of message should be repeated, time at which a message should commence broadcasting, determining pre-download with deactivate flag enabled, and determining when to activate the deactivate flag.

Thus, the iPPG is able to transmit data content (to be broadcast) in advance with the receiver display deactivate flag enabled (data content is not activated). At prime time or at a predetermined broadcast time, the display deactivate flag is enabled, thereby making the pre-downloaded broadcast content available for presentation to the receiver.

Furthermore, the iPPG initiates transmission by sending fixed-length short messages to the exciter, and when necessary, pads the message with appropriate characters to a length of fixed octets. It further maintains flow control when received load indication messages indicate an underflow or overflow situation by the exciter (for duplex E interface). Additionally, in one variation, the iPPG is able to route the content to selective iPPG (when more than one iPPG exists and are networked). In this scenario, a centralized gateway performs intelligent scheduling such that same information is not repeated by each station (sharing similar contour coverage), keeps track of available bandwidth, and instructs receivers to look around for other information. Additionally, iPPG determines the neighboring channel (look around) on which the message should be broadcast. The iPPG further routes broadcast messages to the appropriate exciter (in the instance that more than one exciter exists and these exciters are networked).

The iPPG also determines the time at which a message should cease being broadcast and subsequently instructs each exciter to cease broadcast of the message. It also determines the set of geographic and exciter zones to which a message should be broadcast, and indicates the geographical scope of each message (if networked).

Various fields are presented as options for defining various parameters of broadcasting, which advertisers need to select. Generally, these fields are provided in XML/HTML or by HTTP. It should be noted that a broadcast association allocates a service operator code (SOC). In this instance periodicity, refers to the number of times the content is to be transmitted. In the event of a conflict where the iPPG has more than one message to send at the same time, the iPPG decides the order of such messages as a matter of implementation.

An FCC allocated identifier can be used as an operator-defined contour. Thus, the iPPG Pulls the deterministic information from the FCC database and uses this information for contour (latitude, longitude) verification purposes. The zone field identifier provided by ASP identifies which exciter the message applies to. Preferably, the zone-list contains at least one exciter and the iPPG keeps a log of OTA transmissions. The billing management layer or OAM layer uses this information for later use. This parameter is a list indicating the number of times the message has been sent to each exciter and if exciter has completed OTA transmission. It should be noted that the number-of-broadcasts-completed can be set to zero if there were no broadcast messages sent.

To create better-formatted content for a particular iBOC device, the ASP requests the capabilities of a particular device on the iBOC network. The iPPG maintains a OEM device profile database of registered OEMs and may share this information with the ASP. It should be noted that, although a OEM profile database is mentioned in conjunction with the iPPG, one skilled in the art can envision the ASP using other means (such as the Internet) to extract such profile information.

Thus, in summary, the iGateway or iPPG is able to Push data from various content provider centers and is also able to Pull data from remote content providers. The content provider centers and remote content providers are able to communicate with the iPPG via a network (LAN, WAN, Internet, etc.). Based upon the request from the content provider centers, the data is then Pushed via a network such as an IBOC network onto various end devices (clients).

It should be noted that although only one iGateway (or iPPG) is described, one skilled in the art of networked communication can envision using multiple iGateways (or iPPGs), for distributed processing, wherein such gateways are controlled by one or more centralized gateways. Thus, one skilled in the art can envision using various combinations including, but not limited to, one iPPG and many transmitters, a set of networked iPPGs, and a master iPPG and a scaled down iPPG. Furthermore, although the iPPG, remote content providers, and content provider center are shown to be separate entities communicating over various networks, one skilled in the art can envision them as being implemented locally in one single entity.

As mentioned earlier, the Push download at the iPPG is carried out via protocols such as HTTP. It should, however, be noted that the data receiver does not perform any protocol mapping as the ASP uses standard API, which the end device is equipped with, or optionally, the end device equipment is pre-downloaded with non-standard API by using an original equipment manufacturer (OEM) provided serial interface and drivers. Furthermore, the ASP provides a selection of various fields (services and control categories) as provided by the iPPG. Additionally, if a mandatory element is not initialized, the iPPG performs default initialization.

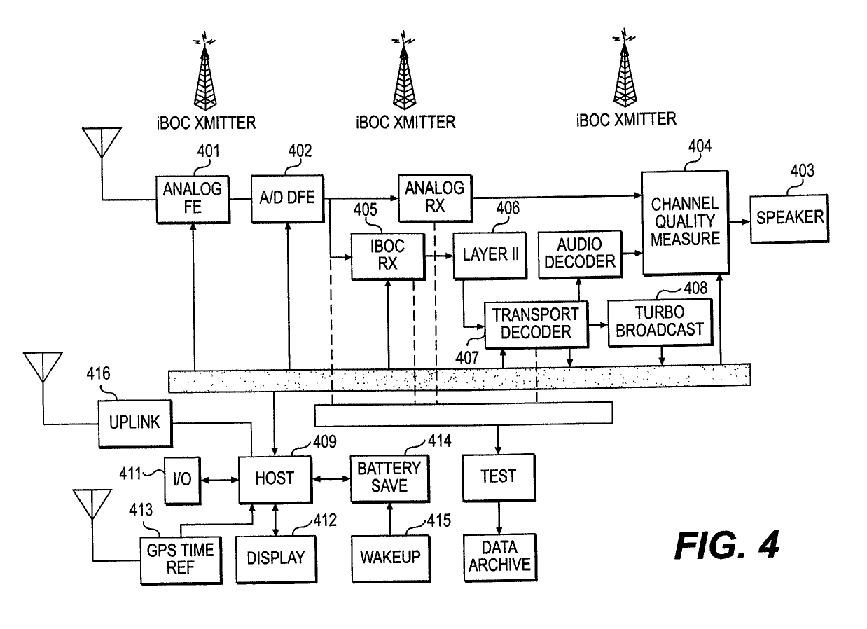

FIG. 4 illustrates how incoming data is handled at the client (receiver's end—an IBOC-enabled mobile device 400). An antenna 401 located on the receiver first receives incoming data, and detection equipment 402 detects such data and optionally amplifies the signal. The received data is then deinterleaved via deinterleaver 405, demodulated via demodulator 406, decoded via a decoder 407, and further decoded via a turbo broadcast layer decoder 408. Audio signals are converted into audible sounds and are forwarded to the speaker 403. Additionally, the detection equipment 402 uses a channel quality measurer 404 to calculate the quality associated with tuned channel. It should be noted that the processing unit 409 actively controls the above-described deinterleaver, demodulator, decoder, and turbo broadcast layer decoder. Lastly, the processing unit and memory 410 process the decoded data before being presented to the end user device, via a display device 412 (with input 411). The input/output (I/O) 411 is used with MMI for storing private keys used to decode the broadcast data (including filtration initialization), wherein such keys are stored in ROM/RAM 410.

A GPS system 413 is also included for receiving coordinate-related information. Additionally, the receiver also has a battery save module 414 that, when activated, saves battery energy by deactivating the receiver when scheduled transmissions not of interest are taking place. A wakeup function 415 is provided for activating the receiver when scheduled transmissions of interest are taking place to the receiver. In addition, an uplink module 416 is also provided for uploading profile related information to the iPPG via an existing wireless network.

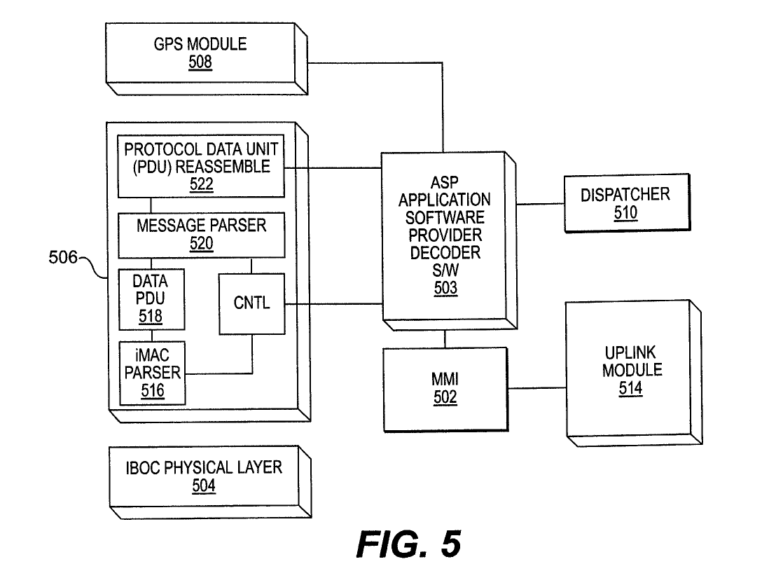

FIG. 5 illustrates in greater detail the interaction between the turbo broadcast (506), the ASP 503, and the iBOC physical layer 504. A man machine management module 502 interacts with ASP 503 to extract data transmitted by the iPPG. This data is presented upon demand (cached) in real-time to the listener's MMI 502. The listener can select what services are being offered by radio station, and indicate if the listener is interested in receiving those services. The items of interest are communicated to TBL 506 to extract data when scheduled by iPPG. The extracted data is then rendered in the end device (e.g., consumer electronics receiver such as a car radio receiver) via a dispatcher 510 that routes the data in a specific format to MMI 502.

Thus, the TBL uses an iMAC parser 516 to parse the received data for control, content and validity, and as a next step, data protocol data units 518 are extracted. Then, a message 520 parser extracts the data PDU's from active and passive queues and with the help of a PDU reassemble means 522. Software application layer 503 interacts with MMI 502 and dispatcher 510 to route the data to the corresponding end user agent. Thus, when a digital receiver (such as iBiquity's iDR™) receives Pushed content, a dispatcher looks at the Pushed message header to determine its destination application. The dispatcher is responsible for rejecting content that does not have a suitable destination application installed and accepting contents that are initialized by the subscriber.

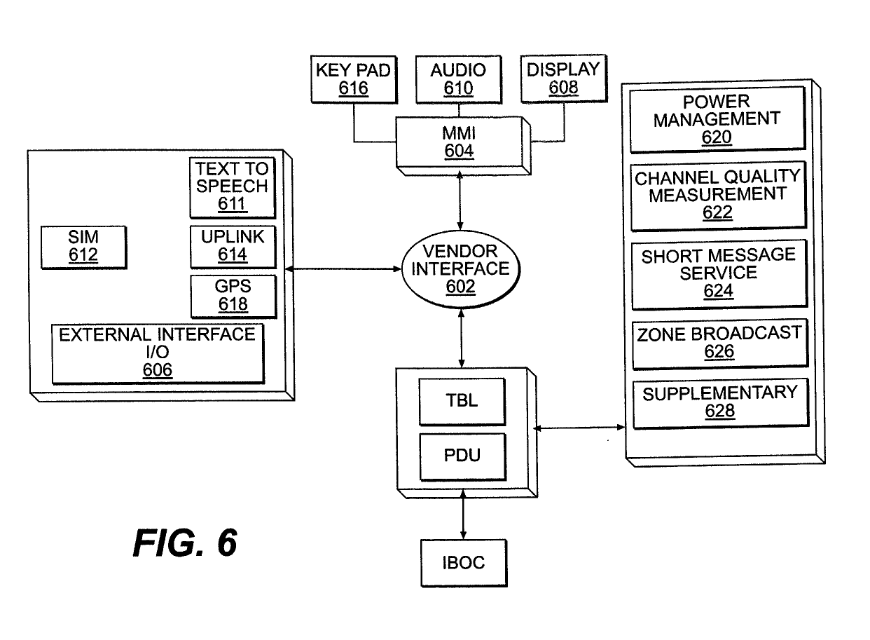

FIG. 6 illustrates a more specific instance of a high end receiver system, wherein the application software layer of FIG. 5 is a vendor interface 602. The vendor interface 602 interacts with a MMI stack 604, which is interfaced with keypad 616, audio 610 and display 608 to provide various services and management solutions. The external interface 606 includes interfacing with SIM 612, an uplink 614 for communicating with the iPPG or the content provider center, and a GPS mechanism 618 for filtration of content with respect to latitude/longitude coordinate information. As described earlier, the services and management improvements include: power management 620, channel quality management 622, short message services 624, zone broadcast 626, and supplementary services 628 (to be described below).

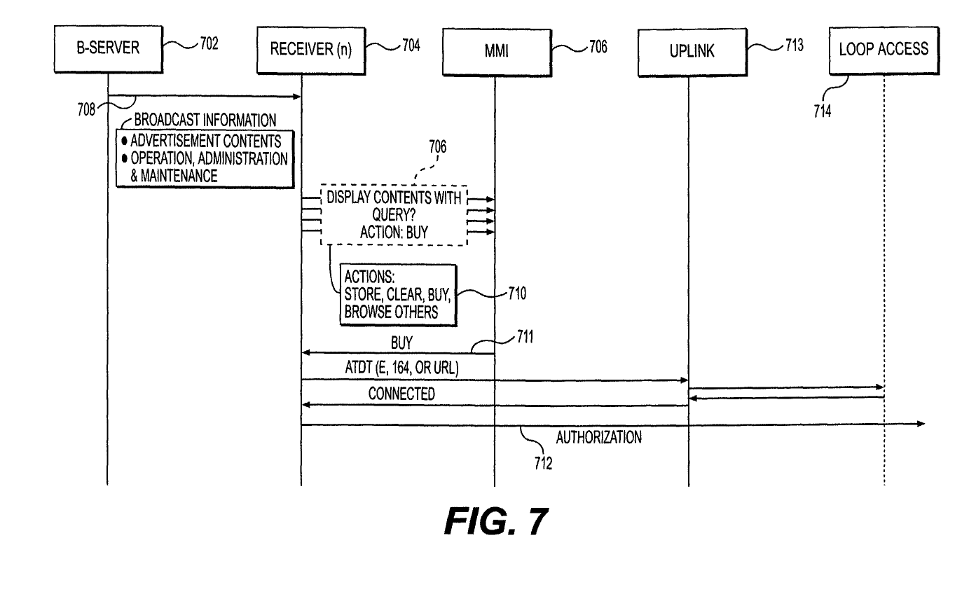

FIG. 7 illustrates the present invention's passive mode point-of-sale (POS) and bulk purchase of data content. Also illustrated is a general time-line diagram showing some of the elements involved in the present invention's system for electronic bulk buying of data content. In this setup, one or more broadcast servers (hereafter B-servers) 702 transmit information to one or more receivers 704 over a network such as an in-band on-channel (IBOC) network. In the preferred embodiment, the broadcast information comprises origination and terminator address (E.164 or URL) advertisement content and may carry administration and maintenance (OAM) instructions.

Next, the receiver 704 receives the broadcast data, processes the received data, and renders the data via a man-machine-interface (MMI) 706. For example, in case of an MMI 706 equipped with a graphical user interface (GUI), the processed broadcast data content is displayed in the GUI along with any advertisement content that was received. Optionally, any originator and terminator addresses are either stored or displayed. Then, based upon the rendered information, the user of receiver 704 performs an action 710 such as pressing a touch-screen button indicating a purchase, which in turn is interpreted by the MMI 706 and the receiver 704, which uses a terminator address and triggers uplink module for a circuit or packet link. If the action 710 involves charging the end user, an authorization step is initiated wherein the end user authorizes 712 a payment for any requested merchandise.

In the above example, the actions taken 710 include, but are not restricted to, storing displayed data content, clearing displayed data content, buying one or more products based upon the displayed advertisements, or browsing other data content and advertisements. It should be noted that although specific examples of actions are given, one skilled in the art of electronic commerce can envision other possibilities, and thus should not use such actions to limit the scope of the present invention.

Such actions performed at the digital audio broadcast receiver's end are tracked and once a predetermined amount, or threshold amount, of actions are accumulated, an order 711 is placed with regard to all the accumulated actions. Thus, in the preferred embodiment, users with a digital audio broadcast receiver are able to request multimedia audio content from content providers, and the requests are tracked until a certain threshold level (e.g., 15 songs) is met. Once this threshold (e.g., 15 songs) is reached, an order is placed through a direct order placement service. Continuing with the example of 15 songs, the 15 songs are then bulk downloaded to the client at the scheduled time or are delivered, e.g., on a compilation CD to a physical address of the end user. Another reason for bulk buying is to accommodate uplink network efficiency. For example, a popular song may cause a lot of hits. If subscribers are most likely to place an order, the uplink access network will not have enough uplink channels to complete the call. Therefore, thresholding helps to spread out uplink access.

It should, however, be noted that although a specific example of digital audio content is used to illustrate the preferred embodiment, one skilled in the art of broadcasting can envision other data content that can be broadcast, including other merchandise which is available for purchase without departing from the scope of the present invention.

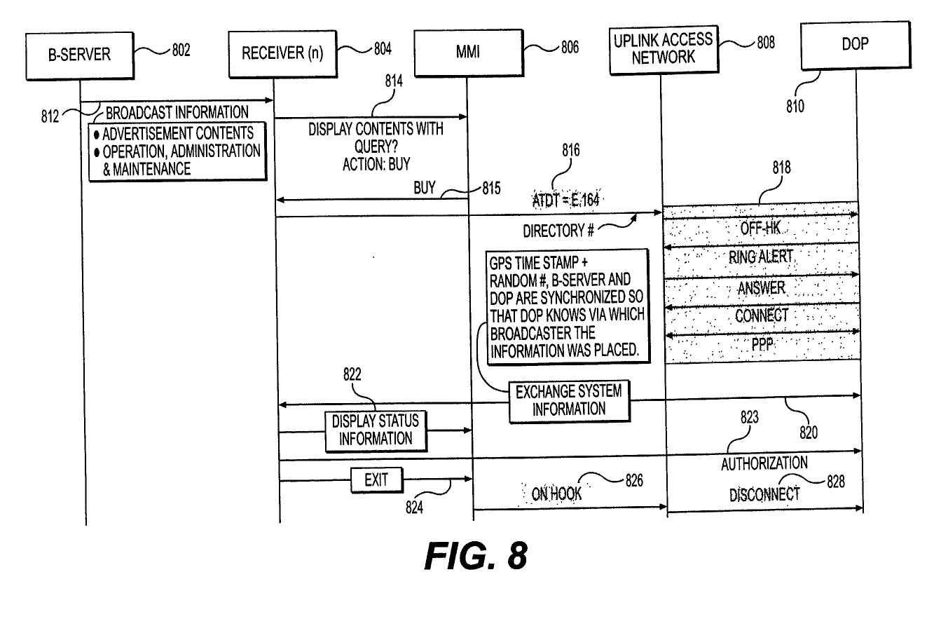

FIG. 8 illustrates a specific embodiment of the present invention's bulk buying procedure shown in FIG. 7. In this specific embodiment, a direct order is placed from a receiver to a direct order service (DOP) without an intermediate entity. This specific embodiment, as shown in FIG. 8, illustrates the present invention's active mode real-time direct order placement using a protocol such as the point-to-point protocol. In this setup, one or more B-servers 802 transmit data content 812 to one or more receivers 804 over a network such as the IBOC network. The transmitted data content primarily comprises advertisement content, with turbo broadcast header and operation administration and maintenance instructions. Next, the receiver 804 parses the broadcast data 812 for terminating address (E.164 or URL) and contents, and renders the data content via a man-machine interface (MMI) 806. Thus, in the instance the MMI 806 is equipped with a GUI, the broadcast data content is rendered (displayed) in the GUI. Then, the receiver's owner is able to view the broadcast content, and based upon the displayed content, one or more actions 814 performed by the user are tracked. In the instance the performed action is a “buy” 815, and if as mentioned earlier the total number of actions (or “buy” actions in this case) is equal to or greater than a predetermined threshold, the MMI 806 connects to a direct order placement (DOP) service 810 via a network such as the circuit or packet network and places an order. The interaction between the receiver 804 and the DOP 810 is described below in greater detail.

First, the MMI 806 establishes a connection to the DOP service 810 via a communication interface of any access network 808. Next, the MMI 806 provides the terminating address (URL or E.164) to “ATDT”, and sends an “ATDT” command 816 to device uplink access interface (e.g., a modem) 808. As the next step, the access network 808 communicates with the DOP 810, via a set of well-known instructions 818, to establish a PPP connection.

In this embodiment, after a PPP connection is established (via instructions 818) between the access 808 and the DOP 810, the receiver 804 and the DOP 810 exchange system information 820 for synchronization and authentication purposes. The exchanged system information 820 includes global positioning system (GPS) time stamp information and station FCC identifier and random numbers, wherein the B-server 802 and the DOP 810 are synchronized so that the DOP 810 knows via which broadcaster an order was placed.

Next, once system information is successfully exchanged, an order is placed with the identified broadcaster, or optionally, an order with an entity as indicated by the identified broadcaster. After that, the receiver 804 displays information regarding the status of the order 822 via the MMI 806. If the action 814 involves charging the end user, an authorization step is initiated wherein the end user authorizes 823 a payment for any requested merchandise. Upon final confirmation from the user regarding end of transactions, an exit signal 824 is sent from the receiver 804 to the MMI 806, which in turn issues an “on-hook” command 826 to disconnect the access network 808 from the DOP 810.

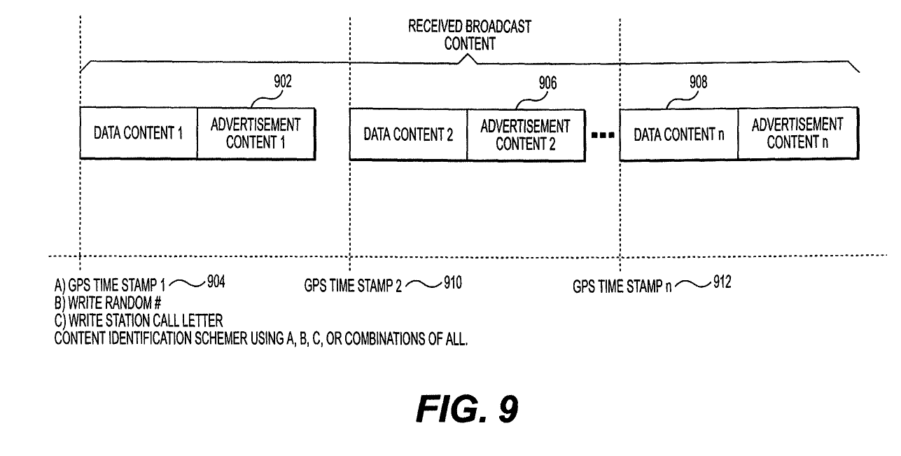

During this time display status 822 information is being sent to MMI to help the listener what actions are being carried on. Once transaction is completed 823, an exit 824 is generated by the receiver 824 which instructs MMI 806 to go on-hook, and a graceful disconnect 828 is issued. The DOP 810 now has complete information about content, and listener data and can complete the transaction. As no standard defines the content's unique identification, e.g., same song can get different identifier when played from same station or different stations. Therefore content is time tagged with a GPS time stamp and a random number (further explained in FIG. 9).

FIG. 9 illustrates the relation between a GPS time stamp and broadcast data content. As mentioned earlier, each broadcast by the iPPG contains data content and advertisement content. Furthermore, when the receiver (as described in FIG. 4) receives the broadcast data content, a GPS time stamp is determined in relation to the received content. For example, when the receiver (in FIG. 4) receives a first set of broadcast content 902, a GPS time stamp (GPS Time Stamp 1 904) is determined for this specific set of broadcast content. Similarly, GPS time stamps (910 and 912) associated with other broadcast content (906 and 908) are also marked.

Referring back to FIG. 8, when the client inputs an “action”, such as “buy”, via receiver 804 and MMI 806, based upon the broadcast information, the GPS time stamp associated with that specific broadcast is recorded. The time stamps are a part of the system information that is exchanged between the receiver 804 and the DOP 810. These time stamps help the DOP 810 in identifying the specific advertisement merchandise or the specific data content (that was rendered in the receiver) that caused the user to record a “buy” action. This allows the DOP to know which broadcaster caused which “buy” action. Additionally, the step of exchanging system information also includes an additional step of comparing a random number for unique identification of content. Unique identification can also be achieved by DOP by combining GPS time stamp and FCC allocated station ID, called “station call letter”.

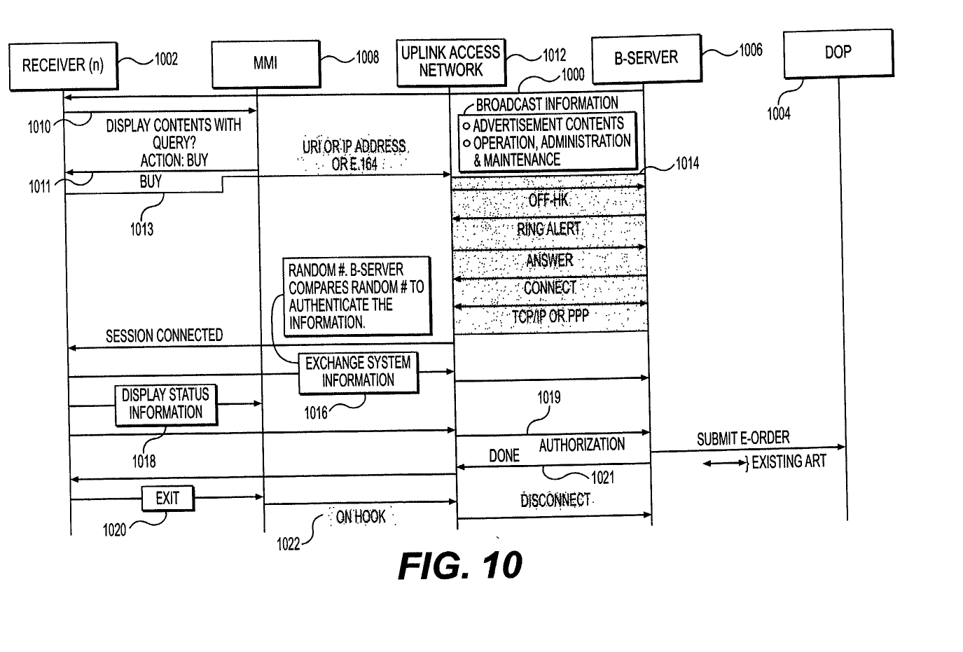

FIG. 10 illustrates the present invention's active mode real-time indirect order placement using transmission control protocol/Internet protocol (TCP/IP). In this embodiment, one or more receivers 1002 receive broadcast content from one or more broadcast servers 1008. Unlike the embodiment in FIG. 8, the embodiment in FIG. 10 involves indirect order placement, wherein an order is placed from a receiver 1002 to a DOP 1004, via an intermediate entity (a B-server 1006).

In this embodiment, once broadcast content 1000 is received, a receiver 1002 renders the content via a MMI 1008 (e.g., via a GUI that is a part of the MMI 1008). Next, the receiver 1002 displays action choices 1010 such as Query, Buy, Store, and Clear. Based upon the action “buy” 1011, the MMI 1008 associated with the receiver 1002 connects to the B-server 1006 via a communication interface (e.g., a modem) or any uplink access network supported by the client device 1012. As a next step, the uplink access network interface 1012 exchanges a set of commands 1013 and 1014, and establishes a communication link, such as a TCP/IP link, with the B-server 1006.

Next, the receiver 1002 and the B-server 1006 exchange system information 1016 for completing any transactions requested by the user of receiver 1002. The information exchanged primarily 1016 comprises a random number comparison, wherein the B-server 1006 compares random numbers for authentication purposes. It should be noted that, unlike in the embodiment described in FIG. 6, there is no need for exchanging any GPS time stamp information, since the B-server 1006 is already aware of the broadcast information to which the “action” was directed towards.

After the system information 1016 is successfully exchanged, the receiver 1002 displays information regarding the status of the order 1018 via the MMI 1008. This status information primarily indicates whether or not the B-server has been successfully intimated to place an order. If the action 1010 involves charging the end user, an authorization step is initiated wherein the end user authorizes 1019 a payment for any requested merchandise. Upon final confirmation from the B-server 1006 regarding the status information, an exit signal 1020 is sent from the receiver 1002 to the MMI 1008, which in turn issues an “on-hook” command 1022 to disconnect the access network 1008 from the B-server 1006.

Lastly, the B-server places the electronic order to the direct order placement service 1004, which in turn makes sure the order is processed and the requested content or product is sent to the requestor.

Thresholding, done at the receiver, is vendor (OEM) specific. The listener is asked for thresholding via the MMI, and thresholding is dependent on client device's class. More memory means you can store more content. When the thresholding field is initialized and when this limit is received, the receiver instructs uplink access module 514 or I/O 504 of FIG. 5 to initiate active or passive Buy/Query interaction.

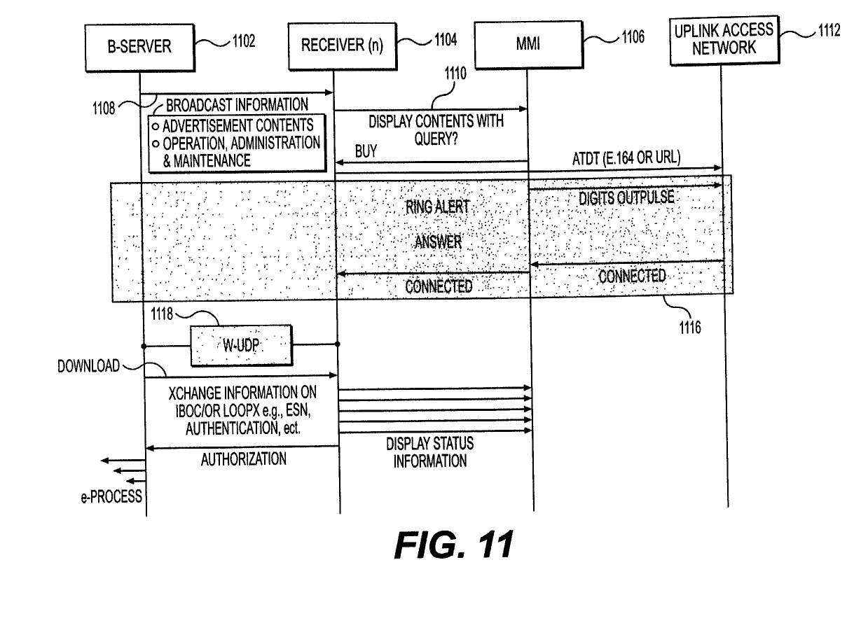

FIG. 11 illustrates the active mode real-time indirect order placement embodiment of the present invention, wherein communication between a receiver and the B-server is accomplished via wireless datagram protocol (WDP) (the same can be done via a file transfer protocol (FTP) such as iBiquity's proprietary iFTP™). In this embodiment, the broadcast information is sent from the B-server 1102 to the receiver 1104. Next, the broadcast content is processed and rendered via a MMI 1106. In the instance the MMI 1106 comprises a graphical user interface (GUI), the broadcast content is visually rendered (displayed) in the GUI.

Then, the user of receiver 1104 performs an “action” 1110 (“buy”), which alerts the MMI 1106 to establish a communication link between the receiver 1104 and the B-server 1102. The MMI 1106 is equipped with a communication interface (any uplink access network 1112), which is capable of communicating with a network call center (N/W-X 1114) associated with the B-server 1102. Thus, after the receiver uplink access and B-server (or call center) interfaces exchange a set of instructions 1116, a virtual wireless data protocol (WDP) link is established 1118 between the B-server 1102 and the receiver 1104.

B-server (or call center) performs the exchange of system information, wherein such information include, but is not limited to, IBOC parameters, uplink access parameters, electronic serial numbers (ESNs), random numbers, authentication data, etc. During this process, the receiver 1104 displays the status information regarding actions between call center and B-server. The B-server through its uplink instructs receiver the time of day when it intends to broadcast. In this way a virtual wireless data protocol (WDP) link is established 118 between B-server 1102 and the receiver 1104.

Furthermore, in another embodiment, the thresholding that is done at the receiver or the iPPG is based upon time, instead of the number of songs. For example, the receiver can have a preset threshold of one hour, wherein if the requested content has reached this limit (of one hour's worth of requested content or 8 hours have since a request for buy has been made), an order is placed (or processed) for the delivery of the content to the receiver. Thus, the thresholding is done based on either the amount of requested data content (for example, a threshold of 15 songs) or the time associated with the transmission of requested content (for example, an hours worth of music to be downloaded). The default thresholding associated with the receiver is stored on a memory chip. This method of bulk downloads is iPPG directed, where, iPPG collects information from various receivers. For certain items of interest, it informs receivers the schedule when it will broadcast such items. Thus, instead of the call center, the B-server does everything, and all downloads are done directly over the iBOC to receivers.

In an extended embodiment, the threshold associated with the receiver is changed via a network such as the Internet. Thus, the threshold is modifiable by the users of the receiver, the broadcasters, or the content providers themselves. The content providers are also able to have package thresholds, wherein actions are recorded after delivering a series of songs and commercials to the receiver. Next, based upon the action input at the receiver's end, the DOP is notified of any orders that need to be placed. Thus, in this instance, the content providers decide how many songs and advertisement comprise the package to be transmitted.

The present invention includes a computer program code based product, which is a storage medium having program code stored therein, which can be used to instruct a computer to perform any of the methods associated with the present invention. For example, the computer program code based products incorporate software modules for receiving broadcast information comprising advertisement content and data content; processing the received data; rendering processed content to a user; recording inputs related to rendered content from a user; establishing a communication link for exchanging system information comprising random numbers and GPS time stamp information; rendering status information regarding recorded inputs; and placing an electronic business order based upon recorded inputs and any user actions regarding the status information. The computer storage medium includes any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM or any other appropriate static or dynamic memory, or data storage devices.

Additionally, as well known in the art, the above-described programming may be implemented in various computing environments. For example, the present invention may be implemented across a multi-nodal system (e.g., LAN) or networking system (e.g., Internet, WWW, wireless web). The programming of the present invention may be implemented by one of skill in the art of network communications, mark-up language and protocol programming.

It should be noted that although the above embodiments describe an authorization step in the time-line, one skilled in the art of electronic commerce can envision other possibilities and other specific locations in the time line for performing such authorizations. Thus, the specific location of the authorization step in the time line diagrams in each of the above-described embodiments should not be used to limit the scope of the present invention. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware, choice of communication protocols, location of the broadcast server, location of the direct order placement service, number or broadcast servers, number of transmitters, number of receivers, number of Push/Pull gateways, or the type of man-machine-interface

I claim:

1. A method for bulk purchasing of data content, said method comprising:
receiving broadcast information comprising advertisement content and multimedia data content;
rendering said broadcast information using a man-machine interface;
tracking one or more actions entered in said man-machine interface in response to said rendered broadcast information, said actions associated with multimedia data content of interest; and
accumulating said actions until a predetermined threshold is reached, and upon reaching said threshold:
establishing a communication link with an order placement service;
exchanging system information;
authenticating said receiver based upon said exchanged system information;
synchronizing said order placement services with a broadcast server; and

2. A method for bulk purchase of data content, as per claim 1, wherein said actions include any of the following: storing said rendered broadcast data, clearing said rendered broadcast data, purchasing products advertised in said rendered broadcast data, purchasing said multimedia data content of interest, or browsing other broadcast data.

3. A method for bulk purchase of data content, as per claim 1, wherein said exchanged system information comprises time stamp information and random number information.

4. A method for bulk purchase of data content, as per claim 3, wherein said time stamp information is a global positioning system (GPS) time stamp.

5. A method for bulk purchase of data content, as per claim 3, wherein said step of authentication is based upon said random number information.

6. A method for bulk purchase of data content, as per claim 3, wherein said step of synchronizing is based upon said time stamp information.

7. A method for bulk purchase of data content, as per claim 1, wherein said man-machine interface further comprises a graphical user interface (GUI).

8. A method for bulk purchase of data content, as per claim 1, wherein said communication link is established via any of the following protocols: point-to-point protocol (PPP), transmission control protocol/Internet Protocol (TCP/IP), user datagram protocol (UDP), or wireless datagram protocol (WDP).

9. A method for bulk purchase of data content, as per claim 1, wherein said method further comprises the step of electronically receiving said multimedia content of interest.

10. A method for bulk purchase of data content, as per claim 1, wherein said method further comprises the step of delivering said multimedia content of interest on an article of manufacture.

11. A method for bulk purchase of data content, as per claim 10, wherein said article of manufacture is any of the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, or SDRAM.

12. A method for bulk purchase of data content, as per claim 1, wherein said broadcast information is broadcast over an in-band on-channel (IBOC) network.

13. A method for bulk purchase of data content, as per claim 1, wherein said predetermined threshold is any of the following: a threshold indicating number of actions to be recorded before placing said electronic order, or a threshold indicating either a download time limit or content size, before placing said electronic order.

14. A method for bulk purchase of data content, as per claim 1, wherein said threshold is modifiable over a network.

15. A method for bulk purchase of data content, as per claim 1, wherein said received broadcast information is a format suitable for reception by a consumer electronics receiver.

16. A method for bulk purchase of data content, said method comprising:
receiving broadcast information comprising advertisement content and multimedia data content from a broadcast server;
rendering said broadcast information using a man-machine interface;
tracking one or more actions entered in said man-machine interface in response to said rendered broadcast information, said actions associated with multimedia data content of interest;
establishing a communication link with said broadcast server;
exchanging system information comprising at least random number information;
authenticating said receiver based upon said random number information; and
receiving a confirmation notice from said broadcast server after placing an electronic order regarding said multimedia data content of interest with an order service, said broadcast server placing said electronic order after accumulating a predetermined threshold of such orders.

17. A method for bulk purchase of data content, as per claim 16, wherein said actions include any of the following: storing said rendered broadcast data, clearing said rendered broadcast data, purchasing products advertised in said rendered broadcast data, purchasing said multimedia data content of interest, or browsing other broadcast data.

18. A method for bulk purchase of data content, as per claim 16, wherein said man-machine interface further comprises a graphical user interface (GUI).

19. A method for bulk purchase of data content, as per claim 16, wherein said time stamp information is a global positioning system (GPS) time stamp.

20. A method for bulk purchase of data content, as per claim 16, wherein said communication link is established via any of the following protocols: point-to-point protocol (PPP), transmission control protocol/Internet Protocol (TCP/IP), user datagram protocol (UDP), or wireless datagram protocol (WDP).

21. A method for bulk purchase of data content, as per claim 16, wherein said method further comprises the step of electronically receiving said multimedia content of interest.

22. A method for bulk purchase of data content, as per claim 16, wherein said method further comprises the step of delivering said multimedia content of interest on an article of manufacture.

23. A method for bulk purchase of data content, as per claim 22, wherein said article of manufacture is any of the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, or SDRAM.

24. A method for bulk purchase of data content, as per claim 16, wherein said broadcast information is broadcast over an in-band on-channel (IBOC) network.

25. A method for bulk purchase of data content, as per claim 16, wherein said predetermined threshold is any of the following: a threshold indicating number of actions to be recorded before placing said electronic order, or a threshold indicating either a download time limit or content size, before placing said electronic order.

26. A method for bulk purchase of data content, as per claim 16, wherein said threshold is modifiable over a network.

27. A system for bulk purchase of data content over a network, said system comprising:
a broadcast server transmitting data content comprising advertisement content and multimedia data content;
a receiver receiving said transmitted data content and rendering said data content via a man machine interface, said man machine interface recording one or more actions in response to said rendered data content, said actions associated with multimedia content of interest;
a communication interface operatively linked with said receiver establishing a communication link with said broadcast server, said communication link established after said recorded actions equal or exceed a predetermined threshold; and
an order placement service receiving electronic orders for said multimedia content of interest after said threshold is reached in said broadcast server and delivering said multimedia content of interest.

28. A system for bulk purchase of data content over a network, as per claim 27, wherein said communication interface is an uplink access device.

29. A system for bulk purchase of data content over a network, as per claim 27, wherein said network is an in-band on-channel (IBOC) network.

30. A system for bulk purchase of data content over a network, as per claim 29, wherein said receiver is a consumer electronics receiver.

31. A system for bulk purchase of data content over a network, as per claim 27, wherein said actions include any of the following: storing said rendered broadcast data, clearing said rendered broadcast data, purchasing products advertised in said rendered broadcast data, purchasing said multimedia data content of interest, or browsing other broadcast data.

32. A business method for the bulk purchase of data content, said method comprising:
receiving broadcast information via a receiver comprising advertisement content and multimedia data content;
rendering said broadcast information using a man-machine interface;
tracking one or more actions entered by a client using said man-machine interface in response to said rendered broadcast information, said actions associated with multimedia data content of interest;
accumulating said actions and until a predetermined threshold is reached, and upon reaching said threshold:
establishing a communication link with an order placement service;
exchanging system information;
authenticating said receiver;
synchronizing said order placement services with a broadcast server;
authorizing payment for said multimedia data content of interest; and
placing an electronic order for said data content of interest based upon said synchronization, said electronic order including said authorization information.

33. A system for bulk purchase of data content over a network, as per claim 27, wherein said threshold is any of the following: a threshold indicating number of actions to be recorded before placing said electronic order, or a threshold indicating either a download time limit or content size, before placing said electronic order.

34. A system for bulk purchase of data content over a network, as per claim 27, wherein said threshold is modifiable over said network.

35. An article of manufacture comprising a computer usable medium having a computer readable program code embodied therein which provides for bulk purchasing data content, said article further comprising:
computer readable program code receiving, via a communication interface, broadcast information comprising advertisement content and multimedia data content from a broadcast server;
computer readable program code rendering said broadcast information using a man-machine interface;
computer readable program code tracking one or more actions entered in said man-machine interface in response to said rendered broadcast information, said actions associated with multimedia data content of interest;
computer readable program code establishing a communication link with said broadcast server via said interface;
computer readable program code exchanging system information comprising at least random number information;
computer readable program code receiving authenticating based upon said random number information; and
computer readable program code receiving a confirmation notice from said broadcast server after placing an electronic order regarding said multimedia data content of interest with an order service, said broadcast server placing said electronic order after accumulating a predetermined threshold of such orders.

36. A business method for the bulk purchase of data content, as per claim 35, wherein said actions include any of the following: storing said rendered broadcast data, clearing said rendered broadcast data, purchasing products advertised in said rendered broadcast data, purchasing said multimedia data content of interest, or browsing other broadcast data.

37. A business method for the bulk purchase of data content, as per claim 35, wherein said step of exchanging system information comprises exchanging time stamp information and random number information.

38. A business method for the bulk purchase of data content, as per claim 37, wherein said authentication step is based upon said random number information.

39. A business method for the bulk purchase of data content, as per claim 37, wherein said synchronization step is based upon said time stamp information.

40. A business method for the bulk purchase of data content, as per claim 35, wherein said man-machine interface further comprises a graphical user interface (GUI).

41. A business method for the bulk purchase of data content, as per claim 35, wherein said communication link is established via any of the following protocols: point-to-point protocol (PPP), transmission control protocol/Internet Protocol (TCP/IP), user datagram protocol (UDP), or wireless datagram protocol (WDP).

42. A business method for the bulk purchase of data content, as per claim 35, wherein said method further comprises the step of electronically receiving said multimedia content of interest.

43. A business method for the bulk purchase of data content, as per claim 35, wherein said method further comprises the step of delivering said multimedia content of interest on an article of manufacture.

44. A business method for the bulk purchase of data content, as per claim 43, wherein said article of manufacture is any of the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, or SDRAM.

45. A business method for the bulk purchase of data content, as per claim 35, wherein said broadcast information is broadcast over an in-band on-channel (IBOC) network.

46. A business method for the bulk purchase of data content, as per claim 35, wherein said predetermined threshold is any of the following: a threshold indicating number of actions to be recorded before placing said electronic order, or a threshold indicating either a download time limit or content size, before placing said electronic order.

47. A business method for the bulk purchase of data content, as per claim 35, wherein said threshold is modifiable over a network.

48. A business method for the bulk purchase of data content, said method comprising:
transmitting broadcast information comprising advertisement content and multimedia data content;
establishing a communication link with a receiver;
receiving a predetermined threshold amount of actions from said receiver, said actions associated with multimedia data content of interest;
receiving system information for authentication purposes;
receiving payment authorization information regarding said multimedia content of interest; and
placing an electronic order with an order placement service, said order including said payment authorization information.

49. A business method for the bulk purchase of data content, as per claim 48, wherein said actions include any of the following: storing said rendered broadcast data, clearing said rendered broadcast data, purchasing products advertised in said rendered broadcast data, purchasing said multimedia data content of interest, or browsing other broadcast data.

50. A business method for the bulk purchase of data content, as per claim 48, wherein said communication link is established via any of the following protocols: point-to-point protocol (PPP), transmission control protocol/Internet Protocol (TCP/IP), user datagram protocol (UDP), or wireless datagram protocol (WDP).

51. A business method for the bulk purchase of data content, as per claim 48, wherein said method further comprises the step of electronically receiving said multimedia content of interest.

52. A business method for the bulk purchase of data content, as per claim 48, wherein said method further comprises the step of delivering said multimedia content of interest on an article of manufacture.

53. A business method for the bulk purchase of data content, as per claim 52, wherein said article of manufacture is any of the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, or SDRAM.

54. A business method for the bulk purchase of data content, as per claim 48, wherein said broadcast information is broadcast over an in-band on-channel (IBOC) network.

55. A business method for the bulk purchase of data content, as per claim 48, wherein said predetermined threshold is any of the following: a threshold indicating number of actions to be recorded before placing said electronic order, or a threshold indicating either a download time limit or content size, before placing said electronic order.

56. A business method for the bulk purchase of data content, as per claim 48, wherein said threshold is modifiable over a network.
